(19) United States
(12) Patent Application Publication
(10) Pub. No.: US 2026/0056718 A1
(43) Pub. Date: Feb. 26, 2026

(54) WEBPAGE PROCESSING WITH LARGE LANGUAGE MODELS

(71) Applicant: PAYPAL, INC., San Jose, CA (US)

(72) Inventors: Mozhdeh Rouhsedaghat, Los Angeles, CA (US); Adva Berta Helman, Nofekh (IL)

(21) Appl. No.: 18/809,521

(22) Filed: Aug. 20, 2024

(51) Int. Cl. G06F 8/35; G06F 8/30; G06N 20/00

(52) U.S. Cl. CPC G06F 8/35; G06F 8/31; G06N 20/00

(57) ABSTRACT

A method for processing computer code in order to identify an attribute of the code may comprise receiving a block of code; processing the block of code to identify at least one relevant chunk, generating a set of prompts, each of the set of prompts comprising a respective relevant chunk, and an instruction for a machine learning model configured to cause the machine learning model to generate an output based on the respective relevant chunk. From there, the method may include transmitting the set of prompts to the machine learning model, and generating a conclusion regarding the received block of code based on a set of outputs received from the machine learning model in response to the set of prompts.

### TECHNICAL FIELD

The instant disclosure relates to processing large files with a hierarchical structure using machine learning models, including HTML files, and its extension to incorporating other modalities including webpage screenshots.

### BACKGROUND

Machine learning models, such as large language models (LLMs), are effective tools for processing information. For example, machine learning models can be used to classify or label information in files and other data types, to enhance or add information to files and other data types etc.

One type of file that may be processed by LLMs is a Hypertext Markup Language (HTML) format file. HTML files underlie many webpages and other user interfaces. When a user accesses a webpage, the HTML file is transmitted from the webpage server to the user's device (e.g., through one or more intermediate servers or services), and thus the HTML code underlying the page is accessible by the user device and/or intermediate devices and servers.

### BRIEF DESCRIPTION OF THE DRAWINGS

FIG. 1 is a block diagram of an example system for processing a large data set using machine learning models.

FIG. 2 is a hierarchical tree description of an example HTML document.

FIG. 3 is a sequence diagram illustrating an example method for processing a data set using machine learning models.

FIG. 4 illustrates an example pipeline approach for processing HTML code using machine learning models.

FIG. 5 is a flow chart illustrating an example method for processing a large data set using machine learning models.

FIG. 6 is a flow chart illustrating an example method of processing HTML code using machine learning models.

FIG. 7 is a flow chart illustrating an example method of determining a legitimacy of a large document using machine learning models.

FIG. 8 is a flow chart illustrating an example method of training a machine learning model.

FIG. 9 is a diagrammatic view of an example embodiment of a user computing environment.

### DETAILED DESCRIPTION

Machine learning models, including large language models, generally have a maximum amount of data that can be input at a time. Accordingly, where particular information is to be extracted and classified from a large input, known machine learning models may either be incapable of performing the needed task, or the model that could perform the task would be too large to be computationally feasible for a desired use, such as a substantially-real-time service. The instant disclosure provides an approach for efficiently processing large files, such as hypertext markup language (HTML) format files and multi-modal webpage files, using machine learning models like large language models (LLMs). Such processing may include, for example, classification, generating summaries, and tagging for automated navigation.

HTML files present a particular challenge for machine learning model processing. HTML files can be very large. For example, a typical website has several hundred thousand or more tokens (where a token may be a unit of text that the model processes, for example, a word, subword, character, or punctuation mark). Each token may be a unique input to an LLM, and thus a single LLM of appropriate scale to process such a file (i.e., to accept hundreds of thousands unique inputs at once) would itself be extremely large and require an undesirably large quantity of storage and processing power for implementation.

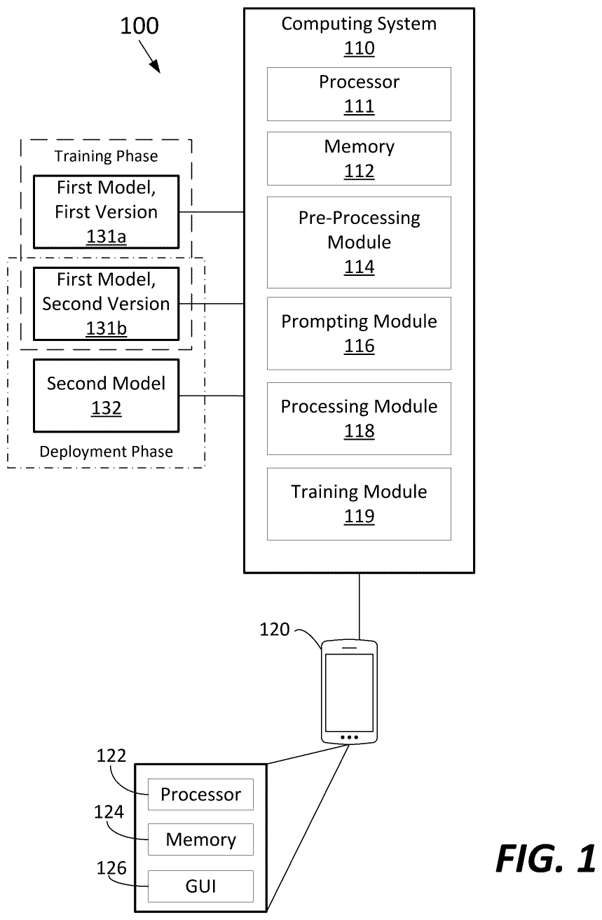

Referring to the drawings, wherein like reference numerals refer to the same or similar features in the various views, FIG. 1 is a block diagram of an example system 100 for processing large data sets using machine learning (ML) models. The system 100 may include a computing system 110, a user device 120, a first ML model 131 (which may have two different versions 131a, 131b), and a second ML model 132, each of which may be in electronic communication with one another and/or with other components via a network. The network may include any suitable connection (or combinations of connections) for transmitting data to and from each of the components 110, 120, 131, 132 of the system 100, and may utilize one or more communication protocols that dictate and control the exchange of data.

As shown, the computing system 110 may include a processor 111 and a memory 112 (i.e., a non-transitory, computer-readable medium) storing instructions that, when executed by the processor 111, cause the computing system 110 to perform one or more methods, operations, functions, algorithms, etc. of this disclosure. The computing system 110 may include one or more functional modules 114, 116, 118, 119 embodied in hardware and/or software. In an embodiment, the functional modules 114, 116, 118, 119 of the computing system 110 may be embodied as instructions in the memory 112. The functional modules 114, 116, 118, 119 may collectively process a large data set, such as a large file using one or more machine learning models 131, 132, as well as train the second model 132.

The user device 120 may include a processor 122 and a memory 124, which may be any suitable processor and memory. In particular, the user device 120 may be a mobile device (e.g., smartphones, tablets, laptops, etc.). The memory 124 may store instructions that, when executed by the processor 122, cause a graphical user interface (GUI) 126 to display on the user device 120. This GUI 126 may be supported, in part, by the computing system 110. The GUI 126 may display a file, webpage based on a file (e.g., HTML file), and/or a summary of a file, where that file was processed by the computing system 110. In some embodiments, a user may navigate to a webpage or other interface in the GUI 126 (e.g., using a browser or application), and the computing system 110 may process the HTML file respective of the webpage or other interface before the HTML file is transmitted to the user device 120.

The first and second models 131, 132 may be or may include any suitable model capable of classifying or labelling one or more aspects of input data. For example, the first and second models 131, 132 may include one or more large language models (LLMs). The first and second models 131, 132 may be trained to predict an unknown output for a known input (e.g., a document or document chunk and instruction). In some embodiments, each of the models 131, 132 may be trained using data that associate files, portions or files, or other data with a corresponding output, such that the first and second models 131, 132 may learn to generate a desired output given received data.

Two versions 131a, 131b of the first model 131 may be included in the system 100. The first model version 131a may be relatively larger, whereas the second version 131b may be relatively smaller. The first version 131a may be used to train the second version 131b. The first version 131a may be, for example, a GPT4 model. The second version may be, for example, a small language model which has distilled knowledge from a more reliable LLM like GPT4. Where a description herein refers to the first model 131 (as opposed to specifying the first version 131a or the second version 131b), it should be understood that the task, input, output, etc. described refers to either version 131a, 131b.

In some embodiments, the first model 131 may be configured to label aspects of an input document as either necessary or unnecessary to a subsequent processing task (i.e., the purpose for which the computing system 110 is applied to the document). For example, where the ultimate processing task is the classification of the document based on its contents, the first model 131 may label portions of the document unrelated to labeling its contents, such as metadata, as unnecessary and substantive portions of the document, such as titles, images, content text, etc., as necessary. In another example, where the ultimate processing task is automated navigation of the document, the first model 131 may label portions of the document unrelated to navigation, such as lengthy textual portions that appear to be detailed content, as unnecessary and portions of the documents, such as headers, titles, and other aspects delimiting sections of the document, as necessary. In another example, where the ultimate processing task is generating a summary of the document, the first model 131 may identify a portion of the file as necessary or unnecessary based on a likelihood that the respective portion of the file would affect the summary. For example, lengthy text portions and images may be more likely to be relevant to a summary, whereas metadata may be less likely to be relevant to a summary. In another example, where the ultimate processing task is to label the document as legitimate or fraudulent, the first model 131 may identify portions of the file that transmit data out of the executing system, receive data from outside the executing system, store user data, etc. as necessary, and portions that perform the substantive task of the file as unnecessary, for example. In some embodiments, the first model 131 may receive, in addition to the input document, an input prompt that identifies the ultimate processing task to assist the first model 131 in identifying aspects as necessary or unnecessary.

The second model 132 may be configured to label portions of an input document and/or to generate other content based on the input document portion. The second model may be a LLM such as a FLAN-T5 model or a Llama2 model. For example, the second model 132 may receive a portion of a document and classify the document portion based on its contents (e.g., legitimate or fraudulent). In another example, the second model 132 may receive a portion of the document and generate navigation labels for locations in the document portion for automated navigation. In another example, the second model 132 may receive a portion of the document and generate a summary of the document portion. The second model 132 may be or may include an LLM, in some embodiments.

Either or both of first and second models 131, 132 may be either locally stored, executed, and accessed on the computing system 110, or may be remote from and accessed by the computing system 110 via network connection.

In addition to text content, either or both of first and second models 131, 132 may accept images, audio, and other non-text content and generate an output based on the input content and an instruction. As described herein with respect to text, the first model 131 may determine if non-textual content is necessary or unnecessary for an ultimate processing task. For example, where the processing task is to generate a summary of the file, the first model may remove header images, logos, and the like as unnecessary, and may label images with captions as necessary. Accordingly, it should be understood that all functionality described herein with respect to textual content (including computer code) may also be applied to multi-modal documents, including documents with images, audio, video, etc.

The functional modules 114, 116, 118, 119 may include a pre-processing module 114 configured to perform pre-processing steps on an input document to make the document suitable for processing by the first model 131 and the second model 132. For example, the pre-processing module 114 may remove certain metadata. Where the input file is an HTML file, the pre-processing module 114 may remove heuristically-selected elements that are not useful for classification, such as comments, cascading style sheet (CSS) code or other style tags, hyperlink and other file path information, and/or other information.

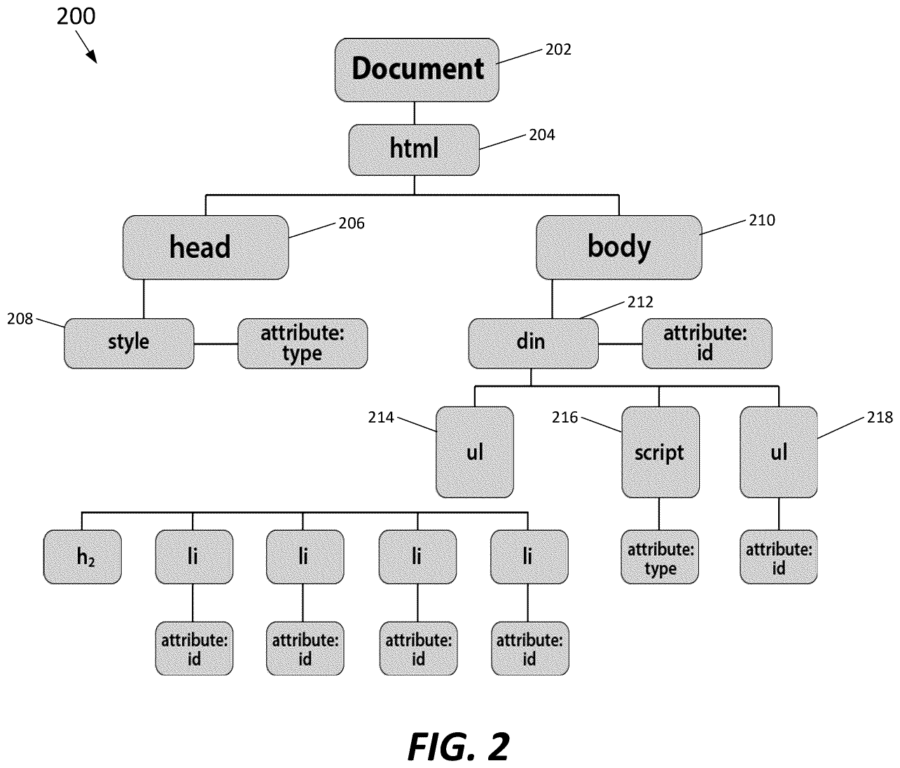

The pre-processing module 114 may also divide the input document up into sub-portions (which may be referred to herein as “chunks”) of an appropriate size for processing by the first model 131 and the second model 132. For example, where the input document is an HTML document, the pre-processing module may traverse a tree of HTML nodes in a depth-first manner to isolate non-overlapping HTML elements that are smaller than a threshold size that can be input to the second model 132 (a “context window” of the first model 132). FIG. 2 illustrates an example hierarchical tree 200 of an example HTML document. In traversing the tree, the pre-processing module 114 may begin with the entire contents of the document 202 and compare the size of the document 202 to the threshold. If the document 202 size is above the threshold, the pre-processing module may move to the <html> portion 204 of the document and compare the size of the <html> portion 204 to the threshold. If the <html> portion 204 size is above the threshold, the pre-processing module 114 may move to the <head> portion 206 (e.g., the document header portion) and compare the size of the <head> portion 206 to the threshold. If the <head> portion 206 is smaller than the size threshold, the pre-processing module 114 may extract the <head> portion 206 as a chunk and continue the process from the next non-overlapping node in the depth-first traversal, i.e., <body> portion 210. If the <head> portion 206 is above the threshold, the pre-processing module 114 may move to the <style> portion 208, and so on. If the size of any portion is below the threshold, that portion may be defined as a chunk.

The smaller of the context window sizes of the first model first version 131a, the first model second version 131b, and the second model 132, in combination with the expected or known size of the prompts to the first model 131 and the second model 132, may be used as the limiting threshold size for document chunks, in some embodiments. In other words, both the document chunk(s) and associated prompt input to a model 131, 132, must fit within the context window of the model 131, 132. Accordingly, the document chunk size maximum threshold may be set based on the smallest context window of the models 131, 132 and of the size of prompts to be provided to the models 131, 132.

Using the process above, the pre-processing module 114 may generate a set of document chunks. In the example described, the chunks are HTML elements. In other examples (e.g., non-HTML documents), the chunks may be otherwise defined. The document chunks may be input to the first model 131. In response, the first model 131 may determine if each chunk is relevant to the target processing task. In turn, the relevant chunks may be input to the second model 132 and, in response, the second model 132 may generate and output one or more labels, summaries, etc. for each relevant chunk.

After chunking an input file (or other piece of code), each portion of the input file may be included in one (and only one) chunk, and the chunks may be non-overlapping with one another. Additionally, when chunks are input to a machine learning model, multiple chunks may be concatenated or otherwise aggregated so that the combined input to the machine learning model is as close to, without exceeding, the context window of the machine learning model as possible.

The functional modules 114, 116, 118, 119 may include a prompting module 116 that determines one or more prompts associated with an input document and provides the one or more prompts along with the input document to the first model 131 in order for the first model 131 to label portions of the document (e.g., chunks) as necessary or unnecessary. The prompt may include the document and an instruction to label portions of the file as necessary or unnecessary for a desired processing task, for example. In some embodiments, the prompting module 116 may determine an instruction by receiving it from a user (e.g., via the user device 120). In some embodiments, the prompting module 116 may determine an instruction by selecting an instruction from several pre-existing instructions based on the document intended use, the document file type (e.g., file extension), a domain of the document (e.g., top-level domain where the document is an HTML file for a page within that domain), or other document characteristic. In response to the prompt(s) and document from the prompting module, the first model 131 may return the document, with portions labelled as necessary or unnecessary, or return a reduced document in which unnecessary portions are removed. As noted above, document chunks may be input to the first model 131. In such embodiments, the first model 131 may return the document chunk, with the chunk labelled as necessary or unnecessary, or with sub-portions of the chunk labelled as necessary or unnecessary, or may return a reduced chunk in which unnecessary sub-portions are removed

The prompting module 116 may also determine one or more prompts associated with file chunks and provide the chunk-specific prompts to the second model 132. Each prompt may include, for example, a chunk of the input document labelled as necessary and an associated instruction for processing that chunk. In response, the second model 132 may return the instructed analysis for the chunk, such as a classification or summary.

The functional modules 114, 116, 118, 119 may include a processing module 118 that receives, as input, the output for each document chunk from the second model 132 and determines a final one or more classifications, labels, summaries, etc. for the input document. For example, where the complete document is to be classified, the processing module 118 may determine a final classification based on the chunk classifications, such as by determining an average of the chunk classifications and designate that average as the final classification. In another example, where a summary of the complete document is to be generated, the processing module 118 may concatenate or otherwise aggregate the chunk summaries into a final summary.

The functional modules 114, 116, 118, 119 may further include a training module 119 that builds a training data set based on the output of the first model first version 131a and trains the first model second version 131b according to the training data set. For example, in some embodiments, the training module 119 may collect training data pairs, each pair consisting of an input prompt (with the prompt itself consisting of a document chunk and an instruction) and the output of the first model first version 131a (e.g., with the chunk or sub-portions of the chunk labeled as necessary or unnecessary) in response to the prompt, with that output treated as the “correct” output for training purposes. Accordingly, the training module 119 may generate a large training data set, in conjunction with the other modules 114, 116, 118, by instructing, for a plurality of documents, chunking of each document, input of each document with generated prompts to the first model first version 131a, and recordation of the responsive output of the first model first version 131a. The training module 119 may then train the first model second version 131b according to the generated training data set.

The training module 119 may also train the second model 132. In some embodiments, the training module 119 may collect training data pairs to train the second model 132. For example, in some embodiments, the training module 119 may collect training data pairs, each pair consisting of an input prompt (with the prompt itself consisting of a document chunk identified as relevant by the first model 131 and an instruction) and its label. For example, in a classification task, the label of each of the document chunks identified as necessary by the first model 131 would be the label of the whole document, which is considered as known for the documents in the training set. Accordingly, the training module 119 may generate a large training data set, in conjunction with the other modules 114, 116, 118, and the first model 131, for a plurality of documents, by chunking of each document, inputting each chunk with generated prompts to the first model 131 and gathering the document chunks identified as relevant by the first model 131 to train the second model 132.

In operation, the computing system 110 may conduct a training phase and a deployment phase. In the training phase, the training module 119 may utilize the pre-processing module 114, prompting module 116, and first model first version 131a to generate a first training data set consisting of documents divided into chunks with portion labels (necessary or unnecessary) generated by the first model first version 131a. The training data set may be used to train the first model second version 131b. In addition, the training module may utilize the pre-processing module 114, prompting module 116, and first model 131 to generate a second training data set consisting of documents divided into chunks with portion labels (necessary or unnecessary) generated by the first model 131, a prompt for each chunk, also including an instruction for processing, and a label for the ultimate processing task (where the label may be prescribed or otherwise known). In some embodiments, after such training, the first model second version 131b may substantially replicate the functionality of the first model first version 131a, but as a much smaller, more efficient model more amenable to fast implementation with less storage space and processing resources required than for the first model first version 131a, and the second model 132 may be used for the ultimate processing task having been appropriately trained.

In the deployment phase, an input document may be pre-processed by the pre-processing module 114, and the prompting module 118 may determine a prompt associated with each chunk and input the prompts to the trained first model second version 131b. The first model second version 131b may label chunks as necessary or unnecessary. The prompting module 118 may determine a further prompt associated with each relevant chunk and input the prompts to the second model 132, which may output a classification or other output as discussed above with respect to each chunk, and the processing module 118 may determine a final classification or other output for the document.

The computing system 110 may provide or support numerous functionalities. For example, the computing system 110 may support a website, network-enabled application, or other network-enabled user interface. When a user navigates to a portion of the interface (e.g., a particular webpage), the computing system 110 may receive an HTML format or other format file representative of the interface portion and process the file according to this disclosure in order to, for example, classify the interface portion, determine a legitimacy of the interface portion (for example, where the computing system 110 or its functionality executes on the user's device, provides a pass-through interface, etc.), before the HTML file is transmitted to the user device 120. In another example, the computing system 110 may provide an on-demand service in which a user may provide a file to the computing system 110 along with an instruction of a desired processing of the file, which the computing system may use to generate prompts as described herein, and return the desired analysis or other processing. In another example, the computing system 110 may be used to audit HTML code of new webpages before those webpages go live (e.g., to ensure that malicious code from public sources was not inadvertently included). In another example, the computing system 110 may support a website, network-enabled application, or other network-enabled user interface which permits third parties to create pages, link to external pages controlled by the third party, or otherwise list the third party's content within a domain under control of the proprietor of the computing system 110. When the third party posts or links new content, the computing system may receive an HTML format or other format file representative of the new content and classify the new content as harmful or harmless, determine whether the content is consistent with content on the third party's own website, or otherwise classify a risk associated with the new content.

In some embodiments, one or more of the modules 114, 116, 118, 119, the first model 131, and/or the second model 132 may be provided on the user device 120. In such an embodiment, for example, when the user accesses a web page, the user device 120 may automatically execute the functionality described herein in order to tag a page for automatic navigation, to display a summary of a page at the top of the page, to classify a page as legitimate or fraudulent before executing its HTML code, and so on.

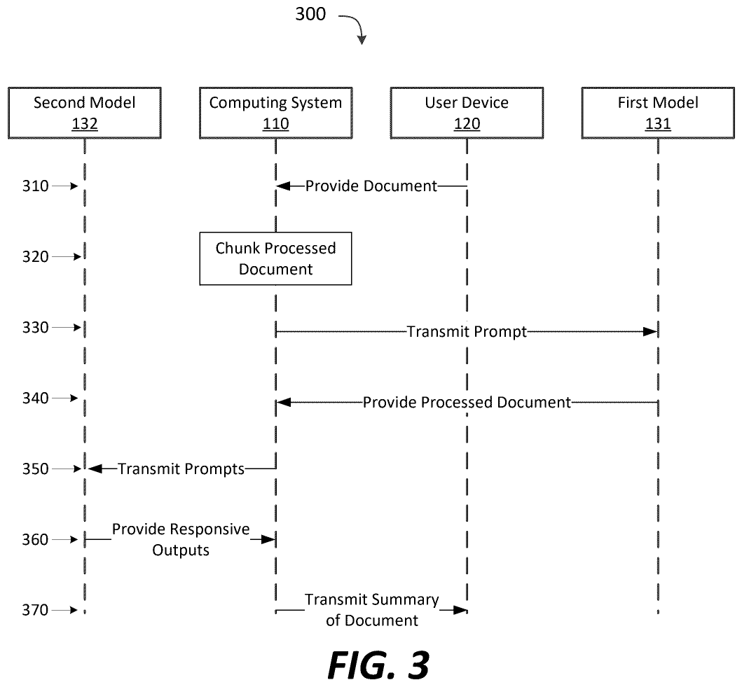

FIG. 3 is a sequence diagram illustrating an example method 300 of processing a file using machine learning models. The method may include, at operation 310, a user device 120 providing a document to the computing system 110, and the computing system 110 receiving the document. The user device 120 may provide the document, for example, in response to a user selecting or providing the document, or in response to the user navigating to a webpage respective of the document. At operation 340, the computing system 110 may divide the updated document into chunks, such that each chunk is below a size threshold processable by the first model 131 and/or the second model 132 (e.g., as described above with respect to FIG. 2).

At operation 330, the computing system 110 may transmit a series of prompts, each of which may include a document chunk and an instruction, to the first model 131. The instruction may guide the first model 131 on the desired output (e.g., “Label this document chunk as necessary or unnecessary for classifying the content of the document”, or “remove portions of this document chunk that are not necessary for classifying the document as legitimate or fraudulent”). In some embodiments, the same prompt may be provided with respect to each chunk. In some embodiments, different prompts may be provided with different chunks. In response, the first model 131 may label portions of the document as necessary and unnecessary (where that is the instructed task), or remove unnecessary portions of the document, and return a processed, updated (e.g., reduced and/or labeled) document to the computing system 110, which may be received by the computing system 110, at operation 340.

The computing system 110 may, at operation 350, generate one or more prompts (each including a chunk and an instruction) and provide each prompt to the second model 132. In some embodiments, the same prompt may be provided with respect to each chunk. In some embodiments, different prompts may be provided with different chunks. In response, the second model may generate one or more outputs respective of each chunk and return those outputs, and the outputs may be received by the computing system 110 at operation 360. In some embodiments, the responsive outputs may be respective summaries or classifications of the document chunks. In response to receiving the responsive outputs, the computing system 110 may, at operation 370, compile a final output for the document, such as a final classification or a final summary, and transmit that final output to the user device 120.

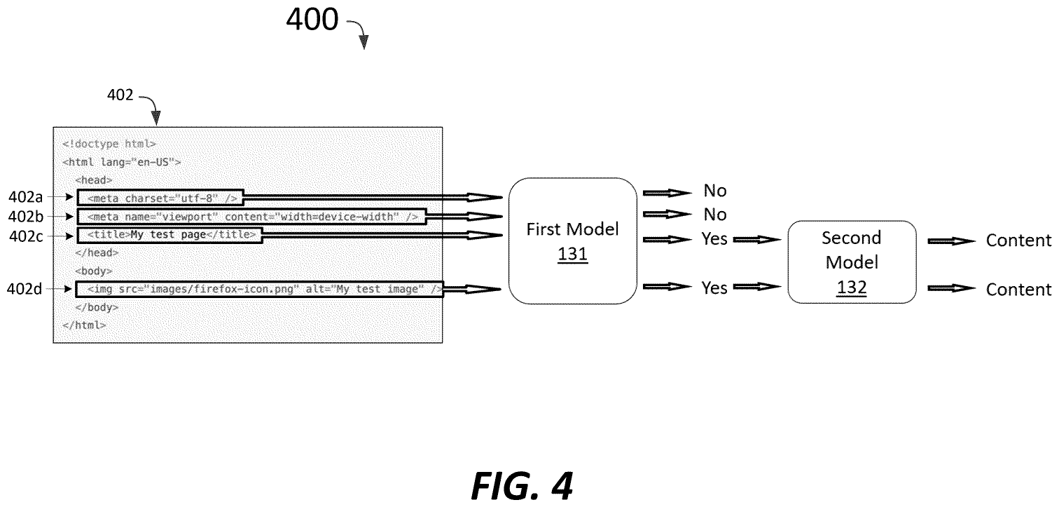

FIG. 4 illustrates an example pipeline approach 400 for processing example HTML code 402 using machine learning models 131, 132. The code 402 may be a chunk from a larger HTML file, for example. The example HTML code 402 may be input to the first model 131, and the first model 131 may label code portions as necessary and unnecessary. In the example shown, the first model 131 labels code portions on a chunk-by-chunk or element-by-element basis.

The first model 131 may label document portions as necessary or unnecessary according to an ultimate processing task for the document. In the example of FIG. 4, the ultimate processing task may be one for which only the substantive content of the document is necessary. Accordingly, four document portions (i.e., four lines of code in the example of FIG. 4) 402a, 402b, 402c, 402d may be input to the first model. The document portions not included in 402a, 402b, 402c, 402d are tags for the parent nodes of 402a, 402b, 402c, 402d, and the content of those parent nodes is substantially covered by 402a, 402b, 402c, 402d. Accordingly, the parent node tags may be ignored when inputting chunks to the models 131, 132, or the parent node tags may be appended to the information in each chunk. In response, the first model may label two lines 402a, 402b with <meta> tags (i.e., document metadata) as unnecessary, and may label two lines 402c, 402d with <title> and <image> tags as necessary. Based on those labels, lines 402c, 402d may be input to the second model 132, whereas lines 402a, 402b may not be input to the second model 132. In response to lines 402c, 402d being input, the second model 132 may generate content (e.g., one or more labels, summaries, classifications, etc.) respective of the lines 402c, 402d.

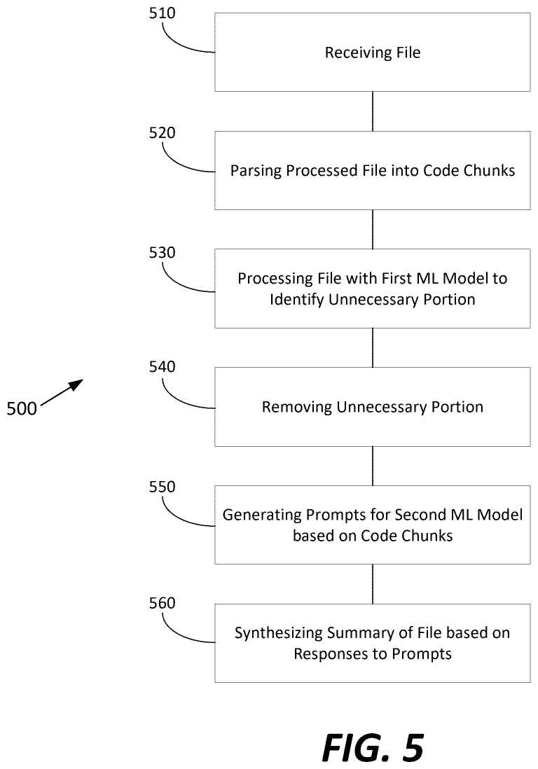

FIG. 5 is a flow chart illustrating an example method 500 for processing a large data set using machine learning models. The method 500, or one or more aspects of the method 500, may be performed by the computing system 110, in embodiments, and thus the method 500 may be computer-implemented or server-implement.

The method 500 may include, at operation 510, receiving a file. The file may be a large file, such as an HTML file, in some embodiments. The file may be received via user designation of the file. For example, a user may navigate to a webpage on a user computing device, thereby designating the HTML file underlying that page for processing. Alternatively, the file may be received via direct user transmission, upload, etc.

The method 500 may further include, at operation 520, parsing the file into code chunks. Operation 520 may include, in some embodiments, identifying a plurality of first elements within the processed file, comparing a size of each of the plurality of first elements to a pre-defined threshold value, in response to the size of a respective first element exceeding the pre-defined threshold value (a “context window” defining the maximum simultaneous input for a particular machine learning model), identifying a plurality of second elements within the respective first element, and repeating the comparing and identifying steps until each identified element is below the pre-defined threshold value. The elements may be identified by traversing an HTML tree, as described with respect to FIG. 2, with each of the elements being respective HTML tagged portions, and the second elements being below the first elements in the HTML hierarchical tree for the file. In some embodiments, the pre-defined threshold value may be based on a context window of a first machine learning model or a second machine learning model.

In some embodiments, operation 520 may include ensuring that each code chunk is as large as possible while remaining within the context window. Accordingly, in addition to progressing downward through the HTML tree, operation 520 may include checking multiple tagged portions in the tree, once a sufficiently small tagged portion is found, to combine multiple portions when possible while remaining within the context window with the combined HTML portions.

The method 500 may further include, at operation 530, processing the received file with a first machine learning (ML) model to identify unnecessary portions. The first ML model may be an LLM, for example, such as a GPT4 model. Alternatively, the first ML model may be a FLAN-T5 model or a Llama2 model which has been trained on distilled knowledge from a GPT4 model, or other relatively smaller model which has been trained on distilled knowledge from a relatively larger model, as described herein. In some embodiments, operation 520 may include providing a prompt to the first ML model, where the prompt includes an instruction that indicates the ultimate processing task or other guidance for the first ML model to enable the first ML model to determine what is necessary and what is unnecessary. In some embodiments, operation 530 may include inputting the entire file to the first ML model as a single input. In other embodiments, operation 530 may include inputting the chunks of the file separately, or inputting combinations of chunks that remain within a context window of the first ML model or a context window of the second ML model.

The method 500 may further include, at operation 540, removing unnecessary portions of the received file. In some embodiments, operation 540 may include deleting portions of the file that the first ML model labeled as unnecessary. In some embodiments, operation 530 may be performed by the first ML model, such that the first ML model deletes file portions determined to be unnecessary by the first ML model. After removing the unnecessary portions, the remaining file may be a “processed file”for purposes of the remainder of the method 500.

The method 500 may further include, at operation 550, generating one or more (e.g., a plurality of) prompts for the second ML model based on the code chunks created at operation 540. In some embodiments, each of the prompts may include a respective code chunk and an instruction for the second ML model. The instruction may be an instruction to the second ML model of the desired analysis, such as to classify the chunk (e.g., as legitimate or fraudulent), to generate a summary of the chunk, and so on. Thus, generating the prompt may include combining the code chunk and the instruction. In some embodiments, the instruction may be identical for all of the prompts. In some embodiments, different chunks may be associated with different prompts, such as according to the portion of the document to which the chunk relates. The instruction(s) may be received from a user, or may be selected automatically from a set of pre-existing instructions, for example.

In response to the prompts at operation 550, the second ML model may generate a respective summary for each chunk (e.g., where the instruction is to generate a summary) or other output, such as an indicator of the legitimacy of the chunk (e.g., a binary/boolean indicator), another label or classification, etc. The method 500 may further include, at operation 560, aggregating a summary of the file (or other final output) based on the responses by the second ML model to the prompts, e.g., the chunk summaries generated by the second ML model. Aggregating at operation 560 may include, for example, combining chunk-level summaries into a file summary, such as by majority vote, average of predicted probabilities, bagging, boosting, or some other appropriate operation on the chunk-level summaries. In some embodiments, the final output may be other than a file summary and may instead be an indication of whether the file is legitimate, for example, or another file-level classification. Where the chunk-level output includes Boolean/binary values indicative of legitimacy, aggregating may include determining a percentage of the generated chunk-level outputs that indicate a legitimate code chunk, and comparing the determined percentage to a threshold value. The method 500 may include providing the aggregated summary or other output in response to receiving the file (e.g., to a user that provided the file).

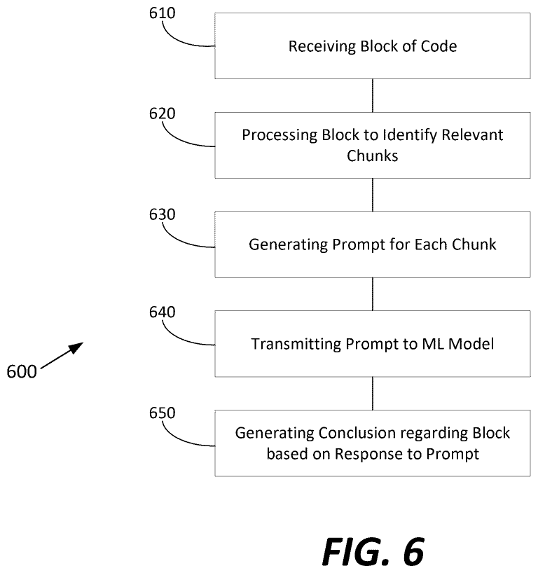

FIG. 6 is a flow chart illustrating an example method 600 of processing HTML code using machine learning models. The method 600, or one or more aspects of the method 600, may be performed by the computing system 110, in embodiments, and thus the method 600 may be computer-implemented or server-implemented.

The method 600 may include, at operation 610, receiving a block of code. The code may be, for example, HTML code. The block may be received via a file containing the block of code being received, for example.

The method 600 may further include, at operation 620, processing the block of code to identify at least one relevant chunk. Operation 620 may include parsing the block of code into chunks by, for example, identifying a plurality of first elements within the block of code, comparing a size of each of the plurality of first elements to a pre-defined threshold value and, in response to the size of a respective first element exceeding the pre-defined threshold value (the context window of the second model), identifying a plurality of second elements within the respective first element, and repeating the comparing and identifying until each identified element is below the pre-defined threshold value. In some embodiments, operation 620 may include generating a prompt for a (first) pre-processing machine learning model, the prompt including the block of code (or a chunk thereof) and an instruction to identify at least one portion (e.g., chunk) of the block of code as unnecessary based on a likelihood that the respective portion of the block of code would affect the generated conclusion. Operation 620 may also include removing the identified at least one portion from the block of code to generate a pre-processed block of code.

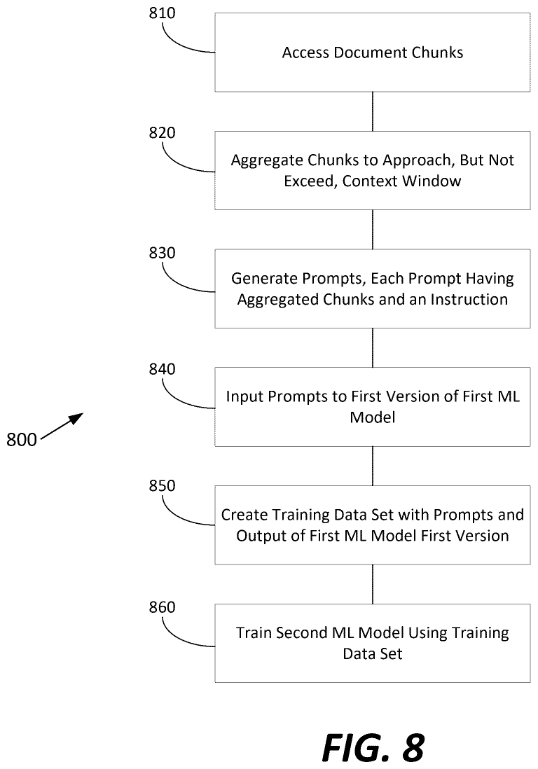

The ML model applied at block 620 may have been trained according to output by another machine learning model, in some embodiments. For example, the ML model applied at block 640 may be a relatively smaller, more computationally-efficient model which was trained according to output of a relatively larger model as described above and with respect to FIG. 8.

The method 600 may further include, at operation 630, generating a further prompt for each relevant chunk and, at operation 640, transmitting the prompt to a second machine learning model. The prompt may include, for example, the relevant chunk and an instruction for how the chunk should be processed. The instruction may be, for example, an instruction to generate a summary of the chunk, to classify the chunk, to tag portions of the chunk for navigation, to calculate a likelihood (e.g., a Boolean/binary likelihood) that the chunk is fraudulent, etc. Transmitting the prompt may be over a network or locally within a same computing system. In response to the prompt, the second ML model may generate an output, such as a summary of the respective relevant chunk, a Boolean/binary value indicative of legitimacy of the chunk, or another indication of whether the respective relevant chunk is legitimate based on the instruction.

The method 600 may further include, at operation 650, generating a conclusion regarding the block based on the response from the second ML model to the prompt. Operation 650 may include, for example, generating a conclusion based on numerous responses from the second ML model to numerous prompts respective of numerous code chunks. Generating a conclusion may include, for example, aggregating a plurality of outputs from the second ML model, such as by majority vote, soft vote, bagging, boosting, compiling, averaging those outputs, determining a percentage of Boolean / binary outputs that indicate a certain value (e.g., legitimate or not legitimate) and comparing that percentage to a threshold value, etc. The generated conclusion may be, for example, an indication of whether the block of code is legitimate, a summary of the block of code, etc. The method 600 may include providing the conclusion to a user in response to receiving the block of code.

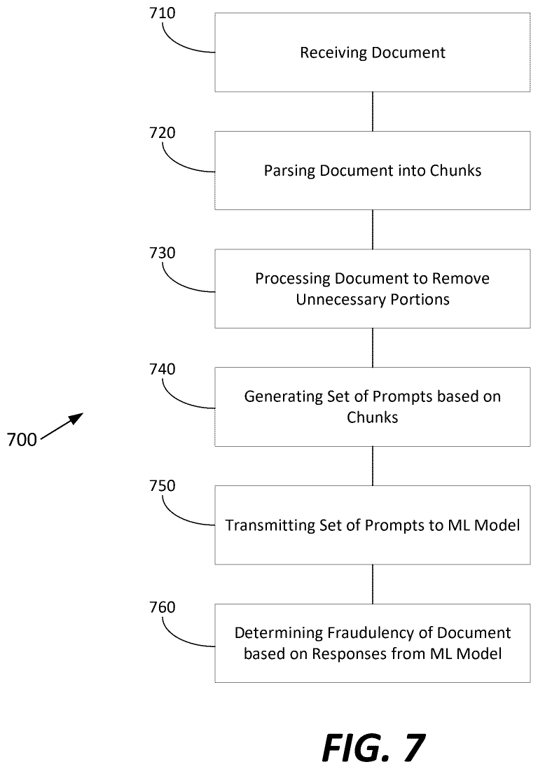

FIG. 7 is a flow chart illustrating an example method of determining a legitimacy of a large document using machine learning models. The method 700, or one or more aspects of the method 700, may be performed by the computing system 110, in embodiments, and thus the method 700 may be computer-implemented or server-implemented.

The method 700 may include, at operation 710, receiving a document. The document may be received from a user.

The method 700 may further include, at operation 720, parsing the document into chunks. Operation 720 may include identifying a plurality of first elements within the document and comparing a size of each of the plurality of first elements to a pre-defined threshold value based on a capacity of the machine learning model. In response to the size of a respective first element exceeding the pre-defined threshold value, operation 720 may include identifying a plurality of second elements within the respective first element, and repeating the comparing and identifying operations until each identified element is below the pre-defined threshold value. Each identified element may be defined as a chunk for further processing. Operation 720 may include identifying the elements according to an HTML tree within the document, in some embodiments.

The method 700 may further include, at operation 730, processing the document (e.g., the chunks) to remove unnecessary portions. Operation 730 may include, for example, providing the document (in its entirety, or separately as chunks or combinations of chunks) as input to a first ML model along with an instruction to label or remove unnecessary portions. In response, the first ML model may label portions of the document as necessary and unnecessary, and the unnecessary portions may then be automatically removed, or the first ML model may remove the unnecessary portions and return a reduced document. After block 730, the document may be considered “processed” for the purposes of the remainder of the method 700.

The method 700 may further include, at operation 740, generating a set of prompts based on the chunks. Each chunk may be associated with a respective prompt. Each prompt may include a respective chunk and an instruction. The same instruction may be used for all prompts at operation 740, in some embodiments. The instruction may be to determine a legitimacy or fraudulence of the chunk.

The method 700 may further include, at operation 750, transmitting the set of prompts to a second ML model. The prompts may be transmitted serially, in some embodiments. In response to each prompt, the second ML model may generate and return an output. Like the prompts, the outputs may be returned serially, in some embodiments. The output may be, for example, a Boolean/binary value indicative of legitimacy of the document chunk in the prompt, or another indication of the legitimacy of the document chunk, such as a percentage or other continuous value or a non-boolean value from a discrete set of values.

The method 700 may further include, at operation 760, determining a fraudulency of the document based on responses from the second ML model. In some embodiments, operation 760 may include determining a percentage of generated Boolean/binary outputs of the second ML model that indicate a legitimate chunk, and comparing the determined percentage to a threshold value. The method 700 may include returning the indication of fraudulence in response to receiving the document.

FIG. 8 is a flow chart illustrating an example method 800 of training a smaller machine learning model version using a larger machine learning model version, so that the second machine learning model version may substantially replicate the functionality of the larger model version with significantly reduced processing demand at runtime. The method 800, or one or more aspects of the method 800, may be performed by the computing system 110, in embodiments, and thus the method 800 may be computer-implemented or server-implemented.

The method 800 may include, at operation 810, accessing a plurality of document chunks. The chunks may be respective of a plurality of documents. The chunks for a given document may be non-overlapping and may comprise the entirety of the document. Each chunk may be smaller than a context window of an ML model to be trained according to the operations below, or the context window of another ML model.

The method 800 may further include, at operation 820, aggregating chunks to approach, but not exceed, a context window (e.g., the context window of the ML model to be trained or another ML model). Chunks may be aggregated by comparing the total size of a given combination of chunks to the context window and aggregating chunks until each document's chunks are optimally combined to be as large as possible while remaining within the context window.

The method 800 may further include, at operation 830, generating a plurality of prompts, each prompt having an aggregated set of one or more chunks and an instruction for processing the aggregated set. The instruction may be, for example: “given the following content, label the content as necessary or unnecessary in order to generate a summary of a document containing the content”; or “given the following content, label the content as necessary or unnecessary in order to classify a webpage containing the content into one of the following categories: contact us, about us, or none”. Each prompt may include the same instruction, in some embodiments. In some embodiments, multiple prompts may be generated for each aggregated chunk set, with each of the multiple prompts having a different instruction from the others.

The method 800 may further include, at operation 840, inputting the prompts to a first ML model. The first ML model version may be a relatively larger LLM, such as a GPT4 model, for example. In response, the first ML model may return the output instructed by each prompt.

The method 800 may further include, at operation 850, creating a training data set that includes, as training data pairs, each prompt and the responsive output from the first ML model version. The training data set thus may include pairs respective of multiple documents or other files, and may include multiple pairs for the same document portions (e.g., where different instructions were provided in different prompts), in some embodiments.

The method 800 may further include, at operation 860, training a second ML model version using the training data set created at operation 850. Training may proceed by providing the prompt of each training data pair as input to the second ML model version and recording the output of the second ML model version. The output of the first ML model version in the pair may be treated as the “correct” response, and the parameters of the second ML model version may be tweaked so as to minimize a loss between the respective outputs of the first and second ML model versions.

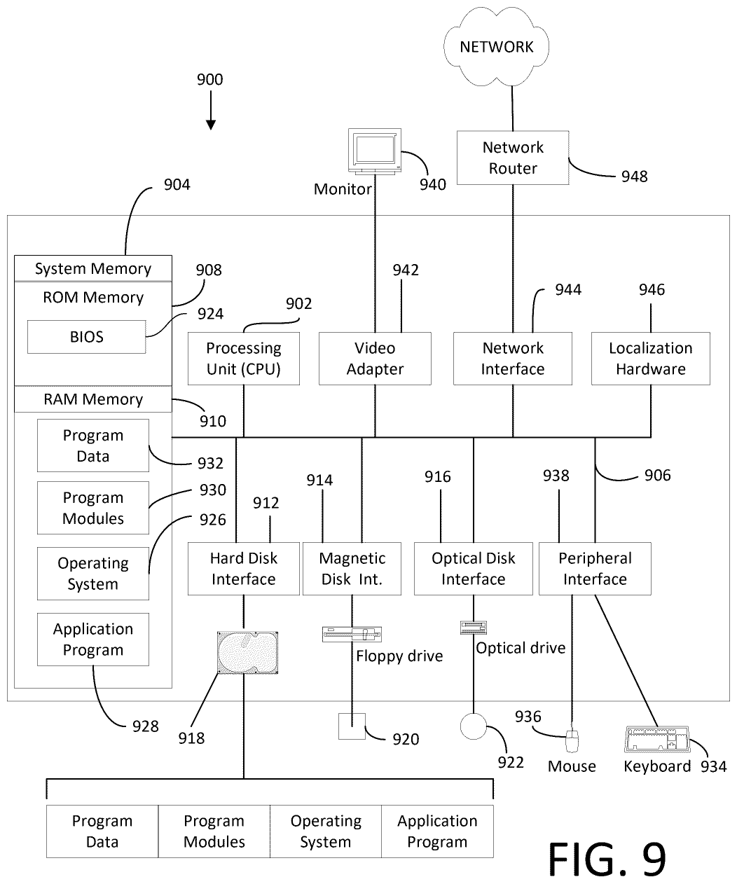

FIG. 9 is a diagrammatic view of an example embodiment of a user computing environment that includes a computing system environment 900, such as a desktop computer, laptop, smartphone, tablet, or any other such device having the ability to execute instructions, such as those stored within a non-transient, computer-readable medium. For example, the computing system environment 900 may be the user device 120 or a system hosting the computing system 110. In another example, one or more components of the computing system environment 900, such as one or more CPUs 902, RAM memory 910, network interface 944, and one or more hard disks 918 or other storage devices, such as SSD or other FLASH storage, may be included in the computing system 110. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 900 typically includes at least one processing unit 902 and at least one memory 904, which may be linked via a bus. Depending on the exact configuration and type of computing system environment, memory 904 may be volatile (such as RAM 910), non-volatile (such as ROM 908, flash memory, etc.) or some combination of the two. Computing system environment 900 may have additional features and/or functionality. For example, computing system environment 900 may also include additional storage (removable and/or non-removable) including, but not limited to, magnetic or optical disks, tape drives and/or flash drives. Such additional memory devices may be made accessible to the computing system environment 900 by means of, for example, a hard disk drive interface 912, a magnetic disk drive interface 914, and/or an optical disk drive interface 916. As will be understood, these devices, which would be linked to the system bus 906, respectively, allow for reading from and writing to a hard disk 918, reading from or writing to a removable magnetic disk 920, and/or for reading from or writing to a removable optical disk 922, such as a CD/DVD ROM or other optical media. The drive interfaces and their associated computer-readable media allow for the nonvolatile storage of computer readable instructions, data structures, program modules and other data for the computing system environment 900. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 900.

A number of program modules may be stored in one or more of the memory/media devices. For example, a basic input/output system (BIOS) 924, containing the basic routines that help to transfer information between elements within the computing system environment 900, such as during start-up, may be stored in ROM 908. Similarly, RAM 910, hard disk 918, and/or peripheral memory devices may be used to store computer executable instructions comprising an operating system 926, one or more applications programs 928 (which may include the functionality of the computing system 110 of FIG. 1 or one or more of its functional modules 114, 116, 118, and 119 for example), other program modules 930, and/or program data 932. Still further, computer-executable instructions may be downloaded to the computing environment 900 as needed, for example, via a network connection.

An end-user may enter commands and information into the computing system environment 900 through input devices such as a keyboard 934 and/or a pointing device 936. While not illustrated, other input devices may include a microphone, a joystick, a game pad, a scanner, etc. These and other input devices would typically be connected to the processing unit 902 by means of a peripheral interface 938 which, in turn, would be coupled to bus. Input devices may be directly or indirectly connected to processor 902 via interfaces such as, for example, a parallel port, game port, firewire, or a universal serial bus (USB). To view information from the computing system environment 900, a monitor 940 or other type of display device may also be connected to bus via an interface, such as via video adapter 942. In addition to the monitor 940, the computing system environment 900 may also include other peripheral output devices, not shown, such as speakers and printers.

The computing system environment 900 may also utilize logical connections to one or more computing system environments. Communications between the computing system environment 900 and the remote computing system environment may be exchanged via a further processing device, such a network router 948, that is responsible for network routing. Communications with the network router 948 may be performed via a network interface component 944. Thus, within such a networked environment, e.g., the Internet, World Wide Web, LAN, or other like type of wired or wireless network, it will be appreciated that program modules depicted relative to the computing system environment 900, or portions thereof, may be stored in the memory storage device(s) of the computing system environment 900.

The computing system environment 900 may also include localization hardware 946 for determining a location of the computing system environment 900. In embodiments, the localization hardware 946 may include, for example only, a GPS antenna, an RFID chip or reader, a WiFi antenna, or other computing hardware that may be used to capture or transmit signals that may be used to determine the location of the computing system environment 900.

In a first aspect of the present disclosure, a system is provided that includes a processor and a non-transitory computer readable medium storing instructions that are executable by the processor to cause the system to perform operations including receiving a file comprising computer code, processing the file, via a first machine learning model, to identify at least one unnecessary portion of the file, removing the at least one unnecessary portion from the file to generate a processed file, parsing the processed file into a plurality of code chunks, generating a plurality of prompts corresponding to the plurality of code chunks, each of the plurality of prompts configured to cause a second machine learning model to generate an output based on the respective code chunk, and aggregating a summary of the received file based on a plurality of outputs received from the second machine learning model in response to the plurality of prompts.

In an embodiment of the first aspect, the computer code is in HyperText Markup Language (“HTML”) format, such that the file is configured to cause the processor to display a webpage.

In an embodiment of the first aspect, the first machine learning model is trained to identify a portion of the file as unnecessary based on a likelihood that the respective portion of the file would affect the aggregated summary.

In an embodiment of the first aspect, parsing the processed file into a plurality of code chunks includes identifying a plurality of first elements within the processed file, comparing a size of each of the plurality of first elements to a pre-defined threshold value, in response to the size of a respective first element exceeding the pre-defined threshold value, identifying a plurality of second elements within the respective first element, and repeating the identifying and the comparing until each identified element is below the pre-defined threshold value. In a further embodiment of the first aspect, the pre-defined threshold value is based on a capacity of the second machine learning model.

In an embodiment of the first aspect, each of the plurality of prompts includes the respective code chunk and an instruction for the second machine learning model, and the instruction is identical for all of the plurality of prompts.

In an embodiment of the first aspect, the generated output is an indication of whether the respective code chunk is legitimate, and the aggregated summary is an indication of whether the file is legitimate. In a further embodiment of the first aspect, the generated output is a binary value indicative of legitimacy, and aggregating the summary includes determining a percentage of the generated outputs that indicate a legitimate code chunk and comparing the determined percentage to a threshold value.

In an embodiment of the first aspect, the generated output is a summary of the respective code chunk, and the aggregated summary is a summary of the file.

In a second aspect of the present disclosure, a computer-implemented method is provided that includes receiving a block of code, processing the block of code to identify at least one relevant chunk, generating a set of prompts, each of the set of prompts including a respective relevant chunk and an instruction for a machine learning model configured to cause the machine learning model to generate an output based on the respective relevant chunk, transmitting the set of prompts to the machine learning model, and generating a conclusion regarding the received block of code based on a set of outputs received from the machine learning model in response to the set of prompts.

In an embodiment of the second aspect, the block of code is in HyperText Markup Language (“HTML”) format and is configured to cause a processor to display a webpage.

In an embodiment of the second aspect, processing the block of code to identify at least one relevant chunk includes generating a prompt for a pre-processing machine learning model, the prompt comprising the block of code and an instruction to identify at least one portion of the block of code as unnecessary based on a likelihood that the respective portion of the block of code would affect the generated conclusion, removing the identified at least one portion from the block of code to generate a pre-processed block of code, and parsing the pre-processed block of code into at least one relevant chunk. In a further embodiment of the second aspect, parsing the processed block of code into at least one relevant chunk includes identifying a plurality of first elements within the processed block of code, comparing a size of each of the plurality of first elements to a pre-defined threshold value, in response to the size of a respective first element exceeding the pre-defined threshold value, identifying a plurality of second elements within the respective first element, and repeating the identifying and the comparing until each identified element is below the pre-defined threshold value.

In an embodiment of the second aspect, the instruction for the machine learning model is identical for all of the set of prompts.

In an embodiment of the second aspect, the generated output is an indication of whether the respective relevant chunk is legitimate, and the generated conclusion is an indication of whether the block of code is legitimate. In a further embodiment of the second aspect, the generated output is a binary value indicative of legitimacy, and generating the conclusion includes determining a percentage of the generated outputs that indicate a legitimate chunk and comparing the determined percentage to a threshold value.

In an embodiment of the second aspect, the generated output is a summary of the respective relevant chunk and the generated conclusion is a summary of the block of code.

In a third aspect of the present disclosure, a computer-implemented method is provided that includes receiving a document, processing the document to remove one or more unnecessary portions, parsing the processed document into a set of chunks, generating a set of prompts, each of the set of prompts including a respective one of the set of chunks and an instruction for a machine learning model configured to cause the machine learning model to generate an indication of whether the respective chunk is fraudulent, transmitting the set of prompts to the machine learning model, and determining whether the received document is fraudulent based on a set of outputs received from the machine learning model in response to the set of prompts.

In an embodiment of the third aspect, the generated output is a binary value indicative of legitimacy, and determining whether the received document is fraudulent includes determining a percentage of the generated outputs that indicate a legitimate chunk and comparing the determined percentage to a threshold value.

In an embodiment of the third aspect, parsing the processed document into the set of chunks includes identifying a plurality of first elements within the processed document, comparing a size of each of the plurality of first elements to a pre-defined threshold value based on a capacity of the machine learning model, in response to the size of a respective first element exceeding the pre-defined threshold value, identifying a plurality of second elements within the respective first element, and repeating the identifying and the comparing until each identified element is below the pre-defined threshold value.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system comprising:
a processor; and
a non-transitory computer readable medium storing instructions that are executable by the processor to cause the system to perform operations comprising:
receiving a file comprising computer code;
processing the file, via a first machine learning model, to identify at least one unnecessary portion of the file;
removing the at least one unnecessary portion from the file to generate a processed file;
parsing the processed file into a plurality of code chunks;
generating a plurality of prompts corresponding to the plurality of code chunks, each of the plurality of prompts configured to cause a second machine learning model to generate an output based on the respective code chunk; and
aggregating a summary of the received file based on a plurality of outputs received from the second machine learning model in response to the plurality of prompts.

2. The system of claim 1, wherein the computer code is in HyperText Markup Language (“HTML”) format, such that the file is configured to cause the processor to display a webpage.

3. The system of claim 1, wherein the first machine learning model is trained to identify a portion of the file as unnecessary based on a likelihood that the respective portion of the file would affect the aggregated summary.

4. The system of claim 1, wherein parsing the processed file into a plurality of code chunks comprises:
identifying a plurality of first elements within the processed file;
comparing a size of each of the plurality of first elements to a pre-defined threshold value;
in response to the size of a respective first element exceeding the pre-defined threshold value, identifying a plurality of second elements within the respective first element; and
repeating the identifying and the comparing until each identified element is below the pre-defined threshold value.

5. The system of claim 4, wherein the pre-defined threshold value is based on a capacity of the second machine learning model.

6. The system of claim 1, wherein:
each of the plurality of prompts comprises the respective code chunk and an instruction for the second machine learning model, and
the instruction is identical for all of the plurality of prompts.

7. The system of claim 1, wherein:
the generated output is an indication of whether the respective code chunk is legitimate, and
the aggregated summary is an indication of whether the file is legitimate.

8. The system of claim 7, wherein:
the generated output is a binary value indicative of legitimacy, and aggregating the summary comprises:
determining a percentage of the generated outputs that indicate a legitimate code chunk; and
comparing the determined percentage to a threshold value.

9. The system of claim 1, wherein:
the generated output is a summary of the respective code chunk, and
the aggregated summary is a summary of the file.

10. A computer-implemented method comprising:
receiving a block of code;
processing the block of code to identify at least one relevant chunk;
generating a set of prompts, each of the set of prompts comprising:
a respective relevant chunk, and
an instruction for a machine learning model configured to cause the machine learning model to generate an output based on the respective relevant chunk;
transmitting the set of prompts to the machine learning model; and
generating a conclusion regarding the received block of code based on a set of outputs received from the machine learning model in response to the set of prompts.

11. The method of claim 10, wherein the block of code:
is in HyperText Markup Language (“HTML”) format, and
is configured to cause a processor to display a webpage.

12. The method of claim 10, wherein processing the block of code to identify at least one relevant chunk comprises:
generating a prompt for a pre-processing machine learning model, the prompt comprising the block of code and an instruction to identify at least one portion of the block of code as unnecessary based on a likelihood that the respective portion of the block of code would affect the generated conclusion;
removing the identified at least one portion from the block of code to generate a pre-processed block of code; and
parsing the pre-processed block of code into at least one relevant chunk.

13. The method of claim 12, wherein parsing the processed block of code into at least one relevant chunk comprises:
identifying a plurality of first elements within the processed block of code;
comparing a size of each of the plurality of first elements to a pre-defined threshold value;
in response to the size of a respective first element exceeding the pre-defined threshold value, identifying a plurality of second elements within the respective first element; and
repeating the identifying and the comparing until each identified element is below the pre-defined threshold value.

14. The method of claim 10, wherein the instruction for the machine learning model is identical for all of the set of prompts.

15. The method of claim 10, wherein:
the generated output is an indication of whether the respective relevant chunk is legitimate, and the generated conclusion is an indication of whether the block of code is legitimate.

16. The method of claim 15, wherein:
the generated output is a binary value indicative of legitimacy, and
generating the conclusion comprises:
determining a percentage of the generated outputs that indicate a legitimate chunk; and
comparing the determined percentage to a threshold value.

17. The method of claim 10, wherein:
the generated output is a summary of the respective relevant chunk, and
the generated conclusion is a summary of the block of code.

18. A computer-implemented method comprising:
receiving a document;
processing the document to remove one or more unnecessary portions;
parsing the processed document into a set of chunks;
generating a set of prompts, each of the set of prompts comprising:
a respective one of the set of chunks, and
an instruction for a machine learning model configured to cause the machine learning model to generate an indication of whether the respective chunk is fraudulent;
transmitting the set of prompts to the machine learning model; and
determining whether the received document is fraudulent based on a set of outputs received from the machine learning model in response to the set of prompts.

19. The method of claim 18, wherein:
the generated output is a binary value indicative of legitimacy, and
determining whether the received document is fraudulent comprises:
determining a percentage of the generated outputs that indicate a legitimate chunk; and
comparing the determined percentage to a threshold value.

20. The method of claim 18, wherein parsing the processed document into the set of chunks comprises:
identifying a plurality of first elements within the processed document;
comparing a size of each of the plurality of first elements to a pre-defined threshold value based on a capacity of the machine learning model;
in response to the size of a respective first element exceeding the pre-defined threshold value, identifying a plurality of second elements within the respective first element; and
repeating the identifying and the comparing until each identified element is below the pre-defined threshold value.
